(19) United States
(12) Patent Application Publication
(10) Pub. No.: US 2011/0115219 A1
(43) Pub. Date: May 19, 2011

(54) INSERT FOR A PIPE-FITTING SYSTEM COMPRISING A FITTING AND A PIPE AND PIPE-FITTING SYSTEM COMPRISING THE INSERT

(75) Inventors: John Biris, Athen (GR); George Hinopoulos, Athen (GR)

(73) Assignee: Halcor Metal Works S.A.

(21) Appl. No.: 12/446,186

(22) PCT Filed: Apr. 4, 2008
(86) PCT No.: PCT/EP2008/054110

§ 371 Date: Jan. 3, 2011

(51) Int. Cl. F16L 17/00

(52) U.S. Cl. 285/345

(57) ABSTRACT

An Insert (4) for a pipe-fitting system comprising a fitting (2) and a pipe (3) is provided. The insert (4) is adapted to be inserted into the fitting (2) and is adapted to receive the pipe (3) an outer diameter of which substantially corresponds to the inner diameter of the inner circumferential face of the insert (4). The inner circumferential face is provided with a sealing portion (4a, 4a1, 4a2) adapted to seal between the insert (4) and the pipe (3) and a holding portion (4d) for holding the pipe (3), being different from the sealing portion (4a, 4a1, 4a2). An outer circumferential face of the insert (4) is provided with at least one circumferential groove (5) for engaging with a deformed portion of the fitting (2).

The present invention relates to an insert for connecting a fitting with a pipe, i.e. to an insert for a pipe-fitting system, and to a pipe-fitting system comprising the insert.

Multilayer pipes, such as pipes made of a plastic material and aluminum (for example: inner layer made from polyethylene (PE); intermediate layer made from aluminum (AL) and outer layer made from polyethylene) or pipes made of a plastic material and copper (for example: inner layer made of copper; outer layer made of polyethylene) are mainly used in water supply systems and heating systems for circulating a fluid and have to resist high pressures inside the system. The multilayer pipes are connected together by special purpose fittings ensuring the pressure resistance between the pipe and the fitting. These fittings are especially designed for the multilayer pipes and have complicated design features that result in relatively high production costs.

Well known are standardized fittings, for example, standardized copper fittings which are used for connecting pipes made completely of copper. These fittings are so called “press-type” fittings and achieve a leak-proof or fluid-tight joint by pressing the fitting with a mechanical press machine once the pipe is inserted. The standardized fittings have a simpler structure and are easier to manufacture than the above mentioned special purpose fittings, and thus they reduce the costs for a pipe-fitting system.

Therefore, it would be advantageous to connect multilayer pipes with standardized fittings instead with special purpose fittings, so that the production costs for the pipe-fitting system would decrease.

From the prior art, for example from document DE 90 01 804 U1, an elastic sealing device with a rigid part for use in a sewage system is known. The sealing device is located between an inner circumferential face of a first sewage pipe and an outer circumferential face of a second sewage pipe, the diameter of the outer circumferential face of the second sewage pipe being smaller than that of the inner circumferential face of the first sewage pipe. Although this sealing device bridges a diameter difference between the inner circumferential face of the first sewage pipe and the outer circumferential face of the second sewage pipe and ensures a fluid tightness between the pipes, it is not suited for enabling a fluid tight connection in high-pressure fluid systems, as a sewage system guides fluid substantially at an atmospheric pressure.

Therefore it is the object of the present invention to provide an insert for a pipe-fitting system comprising a fitting and a pipe, which insert allows to easily and fluid tightly connect the pipe with the fitting which is preferably a standardized fitting, and to provide a pipe-fitting system comprising such an insert.

The object of the present invention is achieved with an insert according to claim 1 and with a pipe-fitting system according to claim 13, respectively.

Further advantageous developments of the invention are subject-matter of the dependent claims.

According to an aspect of the invention an insert for a pipe-fitting system comprising a fitting, preferably a standardized fitting/standardized copper fitting, and a pipe, preferably a multilayer pipe comprising an outer surface made of plastic material, is provided. The insert is adapted to be inserted into the fitting and is adapted to receive the pipe an outer diameter of which substantially corresponds to the inner diameter of the inner circumferential face of the insert. The inner circumferential face is provided with a sealing portion adapted to seal between the insert and the pipe and a holding portion for holding the pipe, the holding portion being different from the sealing portion. Further, an outer circumferential face of the insert is provided with at least one circumferential groove for engaging with a deformed portion of the fitting.

The sealing portion of the insert provides a fluid tight connection between the insert and the pipe. The holding portion ensures that the pipe is securely held in position relative to the insert. The at least one circumferential groove ensures a secure engaging with the fitting, when the deformed portion of the fitting engages with the groove. Accordingly, even in case high-pressure fluid flows through the pipe-fitting system, the fitting, the insert and the pipe do not get loosened relative to each other but are held in firm engagement due to the design of the insert, thereby reliably ensuring the fluid-tightness of the pipe-fitting system.

The above described insert is easy to manufacture at low costs. As result, with such an insert enabling a fluid tight and pressure resisting connection between a pipe and a fitting having a larger inner diameter than an outer diameter of the pipe, the costs for such a pipe-fitting-system are considerably reduced.

Preferably the at least one circumferential groove is provided at a position which is axially distanced from the sealing portion. Preferably, the at least one circumferential groove is provided at a position which corresponds to the position of the holding portion in an axial direction of the insert.

Preferably, the at least one circumferential groove has a rectangular cross-section, but the groove can also have an U-shaped, or V-shaped cross-section.

Preferably the insert has substantially the shape of a hollow cylinder with first and second front faces, an outer circumferential face and an inner circumferential face. Preferably the insert is a rotation-symmetric element.

Preferably the sealing portion is constituted by a first sealing ring disposed in a groove/recess formed in the inner circumferential face of the sealing for sealing between the insert and the pipe. Preferably the groove/recess is formed so deeply or holds the sealing so tightly, that the sealing ring does not move out of the groove/recess when a pipe is inserted into the insert. Preferably the sealing ring is disposed such that it is located at the same axial position with respect to an axial direction of the insert as a sealing ring of the standardized fitting/standardized copper fitting, when the insert is fully inserted to its desired position into the standardized fitting. Therefore, as both sealing rings are arranged in a same plane in a radial direction with respect to an axial direction of the insert, a press-fitting not damaging the sealing ring of the insert can be ensured, as the location, where a pressing of the standardized fitting for forming the deformed portions engaging with the at least one circumferential groove takes place, is at the same distance from both sealing rings in an axial direction of the insert.

In a preferred embodiment the sealing portion comprises further a second sealing ring provided in a groove/recess formed in an inner circumferential face of the insert, wherein the second sealing ring is located at a predetermined distance from the first sealing ring with respect to an axial direction of the insert. The groove/recess is preferably formed so deeply or holds the sealing so tightly, that the sealing ring does not move out of the groove/recess, when the pipe is inserted into the insert. The provision of a further sealing ring ensures the fluid tight sealing between the insert and the pipe further, especially in a case, where the pressing of the standardized fitting to achieve the press-fitting takes place only at one position in the axial direction of the insert.

Preferably the sealing ring is a known sealing ring of a plain circular type (O-ring). The sealing ring can also be a gasket or a sealing device/sealing ring with one or more additional protruding lips extending radially, to improve the sealing performance. In case of a sealing ring having additional lips, the lips are tilted in a direction in which the pipe is to be inserted into the insert. Preferably the sealing ring/sealing device is made of rubber, such as EPDM (ethylene propylene diene monomer Rubber), HNBR (hydrated acrylonitrile butadiene rubber), etc.

The sealing ring/element may also be a composite consisting of two ring portions, one being made of a hard/rigid material, such as a hard plastic or a metallic wire, and the other one being made of an elastic material with good sealing properties like rubber (e.g. NBR (acrylonitrile butadiene rubber), EPDM, HBNR, etc.). Advantageously the sealing ring is a composite consisting of an inner part made of a hard/rigid material, and an outer part at least partially surrounding the inner part made of an elastic material. Alternatively the sealing ring is a composite consisting of an inner ring layer made of an elastic material, and an outer ring layer made of a hard rigid material, laid/laminated onto the first inner ring layer, wherein at least a part of the inner ring layer is adapted to come into contact with an outer circumferential surface of the pipe for sealing between the pipe and the insert. When the sealing ring is formed as a composite as described above, it can be held in place securely due to the hard/rigid material, when the pipe is inserted into the insert, while the elastic material ensures good sealing properties.

Preferably the insert comprises first positioning portion for axially positioning the insert relative to the fitting with respect to an axial direction of the insert. Preferably the first positioning portion is a flange which protrudes at a front face radially outward from an outer circumferential face of the insert with respect to an axial direction of the insert. This flange serves as a stopper which comes in contact with a front face of the (standardized) fitting, when the insert is inserted into an opening of the (standardized) fitting defined by the front face of the (standardized) fitting by a predetermined distance. Thus the desired position of the insert relative to the (standardized) fitting can be ensured. As the flange is always located outside the fitting during an assembly of the fitting with the insert by an assembler, the assembler is provided with a direct visual feedback, when he has moved the insert to its desired position within the fitting. Alternatively a stopper or flange may be provided at the opposite front face of the insert to come into contact with a portion of the fitting protruding into the inside of the fitting, when the insert is inserted to a desired position into the (standardized) fitting.

In order to facilitate the insertion of the pipe into the insert, it is preferred that a transition between an end face of the insert at the side of the insert from where the pipe is to be inserted into the insert and an inner circumferential face of the insert is rounded or chamfered.

In order to facilitate the insertion of the insert into a (standardized) fitting, it is preferred that a transition between an end face of the insert at the side of the insert to be inserted into a standardized fitting and the outer circumferential face of the insert is rounded or chamfered.

Preferably the insert has a second positioning portion for axially positioning the pipe relative to the insert with respect to the axial direction of the insert. Preferably the second positioning portion is a flange provided at an end face of the insert and extending from an inner circumferential face of the insert inwardly. The flange serves as a stopper for stopping/arranging the pipe at a predetermined distance within the insert, when the pipe is inserted from the other end face not having the flange extending inwardly into the insert. More preferably the second positioning portion comprises a section of the insert partially bent inwardly at an end face such that a radial circumferential undercut portion is formed by the bended portion of the insert with respect to an axial direction of the insert. The undercut portion is formed such that it can receive an end portion of the pipe, especially of a multilayer pipe, and thus serves, corresponding to the above described flange, as a stopper for positioning the pipe at a predetermined location inside the insert. In particular the undercut portion may be formed such that it defines a radial circumferential groove at an inner circumferential face of the insert with respect to an axial direction of the insert, the groove being opened in an axial direction of the insert towards a front face of the insert at a side from which the pipe is to be inserted. The groove is adapted to receive the pipe such that the groove encloses an end portion of the pipe. As a result, as the undercut portion/groove encloses/surrounds an end portion of the pipe and thus protects the end portion of the pipe from a fluid flow inside the pipe-fitting system which may have a high velocity, the undercut portion/groove can prevent a delamination of the multilayer pipe (a peeling off of one ore more layers of the pipe). Further, the undercut portion/groove acts as a calibration sleeve for the pipe, i.e. in case the pipe is slightly deformed to have not a round but a slightly oval shape, the undercut portion/groove restores the original roundness of the pipe, when being inserted into the undercut portion/sleeve. Preferably the undercut portion is elastically deformable to such an extent that an end of the pipe can be held tightly in its desired position.

Moreover, the external profile of the undercut portion, i.e. the areas of the undercut portion coming into contact with fluid when the pipe-fitting system is in use, are formed in a streamlined and/or rounded shape, so as to minimize turbulences of a fluid flow and thus reduce a pressure drop along the pipe-fitting-system. Additionally, the profile can be smoothened or be coated with a material smoothening the surface of the profile, so that turbulences of a fluid flow are further reduced.

Preferably the holding portion of the insert consists of at least one protrusion protruding radially inward from an inner circumferential face of the insert and extending in a radial circumferential direction with respect to an axial direction of the insert. The at least one protrusion is slightly elastically deformable and adapted to improve a grip between the insert and an outer surface of the pipe by pressing against/slightly engaging with an outer circumferential face of the pipe, so that the pipe is securely held in position, even when a large fluid pressure acts on the pipe-fitting system. Preferably the at least one protrusion is formed at an axial position with respect to an axial direction of the insert, which is the same as that where the pressing of the (standardized) fitting takes place for press-fitting the standardized fitting, the insert and the pipe together, so that the protrusion securely engages with an outer surface of the pipe and thus holds the pipe surely in position. More preferably the inner circumferential surface of the insert is provided with a plurality of protrusions forming serrated portions. These serrated portions can be provided on the whole inner circumferential surface or only partially. Preferably the serrated portions are provided at axial positions with respect to the axial direction of the insert, where the pressing of the (standardized) fitting takes place for press-fitting the (standardized) fitting, the insert and the pipe together. Preferably the tines of the serrated portions are inclined with respect to the axial direction of the insert so as to facilitate the insertion of the pipe into the fitting, but make it difficult to pull the pipe out of the insert again.

Further, an outer diameter of a part of the outer surface of the insert near the front face of the insert, which is to be inserted into the (standardized) fitting, can decrease slightly toward the front face, so that an insertion of the insert into the fitting is facilitated. Also an inner diameter of a part of the inner surface of the insert near the front face of the insert, from which the pipe is to be inserted into the insert, can increase slightly toward the front face, so that an reception/insertion of the pipe into the insert is facilitated.

Preferably the insert is made of a material having a low elasticity. Preferably the insert is made of a plastic/polymeric material, such as PE (polyethylene), PPSU (polyphenylsulfone), PVDF (polyvinylidene difluoride), PP (polypropylene) etc., which is easy to manufacture at low costs. However, the insert can be also be made of metal. Alternatively the insert may be made of a composite material, wherein the inside of the insert is made of a polymeric or hard plastic material (e.g. PE, PPSU, PVDF, PP, etc.) and at least a part of the outside surrounding the inside is made of an elastic material like rubber (e.g. NBR, EPM, EPDM, TPV (thermoplastic vulcanisate) TPE (thermoplastic elastomer), etc). With the outside being made of the elastic material, the grip between the insert and the (standardized) fitting and also the sealing between the insert and the (standardized) fitting due to an elastic deformation of the elastic material is improved.

According to a further aspect of the invention a pipe-fitting system comprising the above described insert, a fitting, preferably a standardized fitting/standardized copper fitting, and a pipe, preferably a multilayer pipe with an outer surface made of plastic material, is provided. The insert is inserted into the fitting an inner diameter of which is slightly larger than the outer diameter of the outer circumferential face of the insert, and the fitting comprises a sealing element, preferably a sealing ring, extending radially inside the fitting. The outer circumferential face of the insert is substantially smooth and is arranged in contact with the sealing element. The insert receives the pipe the outer diameter of which substantially corresponds to the inner diameter of the inner circumferential face of the insert, wherein the sealing portion of the insert seals between the insert and the pipe and the holding portion of the insert holds the pipe. The at least one circumferential groove of the insert engages with a deformed portion of the fitting.

Preferably, the portion of the fitting engaging with the at least one circumferential groove is deformed as a result of a radial pressing of the fitting. I.e. a portion of the fitting is (plastically) deformed by a radial pressing of the same such that the portion engages with (is pushed into) the at least one circumferential groove preformed in the insert. Accordingly, a firm engagement between the insert and the fitting is provided, even in case high shearing forces act between the insert and the fitting.

Preferably an outer circumferential face of the insert is radially pressed at a plurality of positions around the outer circumference of the fitting, the positions being distanced in predetermined angular intervals around the outer circumference of the fitting.

Preferably the fitting is radially pressed at positions which are axially distanced from the positions of the sealing element of the fitting and the sealing portion of the insert, but which axially correspond to the position of the holding portion of the insert.

Hereinafter the present invention is described more detailed on the basis of preferred embodiments of the invention with reference to the accompanying drawings.

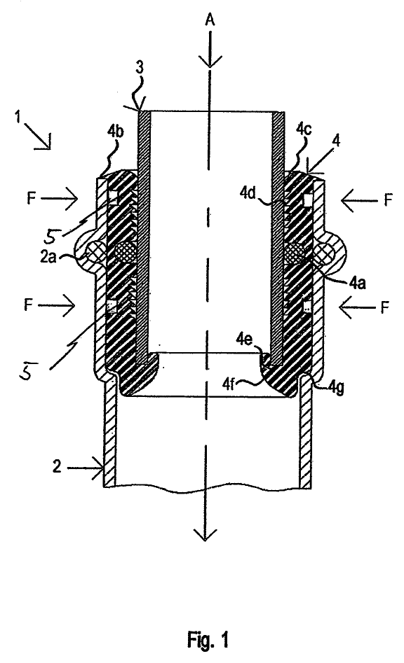

FIG. 1 is a cross-sectional view of a pipe-fitting system in an assembled state comprising an insert according to a first embodiment of the present invention.

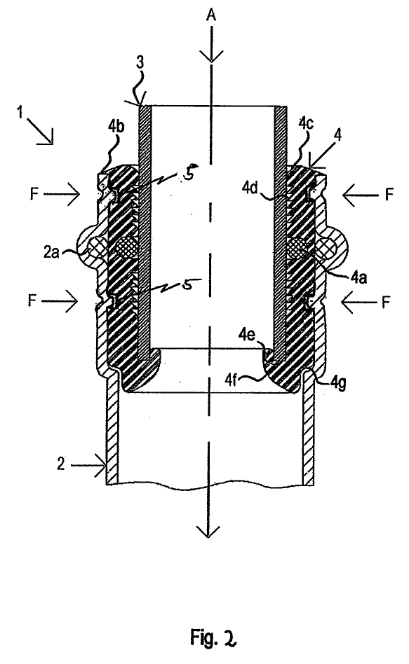

FIG. 2 is a cross-sectional view of the pipe-fitting system of FIG. 1, wherein portions of the fitting have been radially pressed such that the portions respectively engage with the circumferential grooves of the insert.

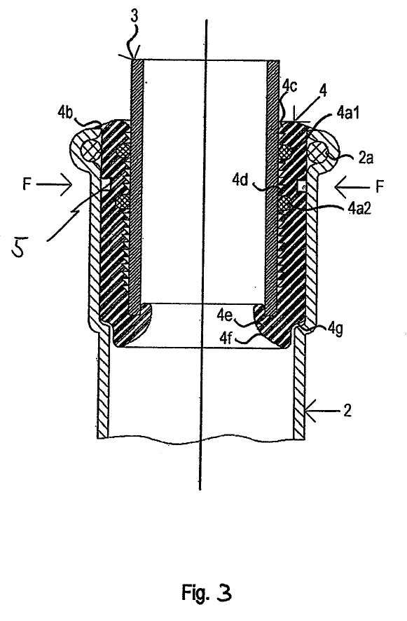

FIG. 3 is a cross-sectional view of a pipe-fitting system in an assembled state comprising an insert according to a second embodiment of the present invention.

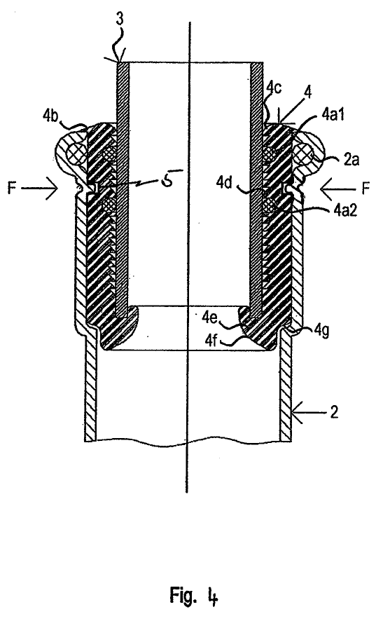

FIG. 4 is a cross-sectional view of the pipe-fitting system of FIG. 3, wherein a portion of the fitting has been radially pressed such that the portion engages with the circumferential groove of the insert.

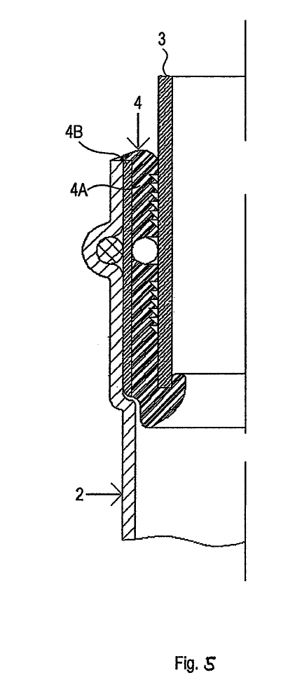

FIG. 5 is a partial cross-sectional view of a pipe-fitting system in an assembled state comprising an insert according to a third embodiment of the present invention.

### FIRST EMBODIMENT

FIG. 1 shows a pipe-fitting system 1 comprising a fitting 2, a pipe 3 and an insert 4 according to a first embodiment of the present invention. The pipe-fitting system 1 is shown in an assembled state, that means a state in which the pipe 3 is inserted into the insert 4 and the insert 4 in turn is inserted into the fitting 2, such that a pressing of the fitting 2 by a pressing means for fluid-tightly press-fitting the pipe-fitting system 1 can be performed.

The pipe-fitting system 1 is preferably used in a water system, a heating system, a floor heating system, a cooling system, etc. Preferably the pipe-fitting system 1 is designed for circulating a high-pressure fluid flow, for example a water flow, with a temperature from 0° C. to 95° C.

The fitting 2 is a standardized copper fitting and complies with the European Standard PR EN 1254 (see for details PR EN 1254, Part 7:“Copper and copper alloys—Plumbing fittings—Part 7: Fittings with press ends for metallic tubes”). The fitting 2 is normally used for fluid tightly connecting copper pipes complying with the standard EN 1057 with each other by press-fitting the fitting 2 with the copper pipes. The preferred range of an inner diameter of the fitting 2 is between 12 and 108 mm. Although the fitting 2 is preferably made of copper, the fitting 2 can also be made of a material other than copper, for example brass, a brass alloy, a zinc alloy, etc. The fitting 2 comprises a sealing ring 2a which is disposed in an outwardly bent portion of the fitting 2 inside the fitting 2, as can be seen from FIG. 1.

Although the pipe 3 is shown in FIG. 1 as a single component, the pipe 3 can be a multilayer pipe well known in the art. Preferably the multilayer pipe consists of an inner layer made of a plastic material like polyethylene, an intermediate layer made of aluminum and an outer layer made of a plastic material like polyethylene or of an inner layer made of copper and an PE-RT outer layer, the respective layers being laminated together. However, the pipe 3 can also have a different number of layers and/or consist of different materials. Although the insert of the present invention is used for connecting multilayer pipes, it also can be used for single-layer pipes.

The insert 4 of the present embodiment is made of PPSU. However, any other material can be employed that has a sufficient rigidity to transmit a pressing force resulting from a pressing of the fitting 2 for press-fitting the fitting 2, the insert 4 and the pipe 3 onto the pipe 3, but is slightly elastically deformable, so as not to break, when the pressing force is applied. The insert 4 has a substantially cylindrical rotational symmetric form with first and second front faces, an outer circumferential face and an inner circumferential face. The first front face is defined as the front face at a side of the insert 4 from which the pipe 3 is inserted into the insert 4 during an assembly of the pipe-fitting system 1, i.e. the upper front face in FIG. 1, and the second front face is defined as the front face at a side of the insert 4 which is inserted ahead into the fitting 2 during an assembly of the pipe-fitting system 1, i.e. the lower front face in FIG. 1. An outer diameter of the outer circumferential face of the insert 4 is slightly smaller than an inner diameter of the fitting 2. An inner diameter of the insert 4 substantially corresponds to an outer diameter of the pipe 3, i.e. the inner diameter of the insert 4 and the outer diameter of the insert differ only slightly to enable a proper fitting between them. The outer circumferential face is formed as a smooth surface over nearly the whole axial length of the insert 4 and is in contact with the sealing ring 2a of the fitting 2 for sealing between the fitting 2 and the insert 4.

At the first front face a flange 4b is formed which extends radially outwardly from the outer circumferential face of the insert 4. The flange 4b functions as a stopper or positioning portion, when the insert 4 is inserted into the fitting 2 and stops a further movement of the insert 4 into the fitting 2, when the insert is located at a desired axial position with respect to the fitting 2. FIG. 1 shows the insert 4 in its desired position, i.e. the position, where the flange 4b abuts against the front face of the fitting 2.

The transition (portion) 4c of the insert 4 between the first front face and the inner circumferential face of the insert 4 is chamfered/rounded to facilitate an insertion of the pipe 3 into the insert 4.

Further, in order to fluid-tightly seal between the insert 4 and the pipe 3, a sealing ring 4a is provided in a recess/groove formed in the insert 4. The recess/groove is formed such as to hold the sealing ring securely in position, when the pipe 3 is inserted into the insert 4 and slides over the sealing ring 4a. As can be seen from FIG. 1, in this embodiment the sealing ring 4a is located at the same axial position as the sealing ring 2a of the fitting with respect to the axial direction of the insert 4 with the sealing ring 2a of the fitting 2 surrounding the sealing ring 4a of the insert, when the insert 4 is fully inserted into the fitting 2 (i.e. in a position, where the flange 4b abuts against the front face of the fitting). This ensures that the sealing ring 4a is not damaged by directly pressing onto the same, when the fitting 2 is pressed for press-fitting the pipe-fitting system 1.

In this embodiment, the sealing ring 4a is a conventional O-ring made of rubber (e.g. EPDM, HNBR). However, the sealing ring can be replaced with any other suitable sealing device, such as a sealing ring having lips, a gasket, etc. Alternatively the sealing ring 4a or the sealing device may be of a composite material, wherein the core is made of a rigid material like a metal wire or a hard plastic material and the coating is made of an elastic material like rubber, so that the sealing ring/device is securely held in place by means of the rigid core, when the pipe 3 is inserted into the insert 4, while the elastic coating guarantees a fluid tightness between the insert 4 and the pipe 3.

The inner circumferential face of the insert 4 is provided with serrated portions 4d for improving an engagement/grip between the insert 4 and the pipe 3, so that the pipe 3 is securely held in place inside the insert 4. The serrated portions 4d extend circumferentially above and below the sealing ring 4a. Preferably the serrated portions 4d are arranged at positions in the axial direction of the insert 4, at which the fitting 2 is pressed by a pressing means for press-fitting the pipe-fitting system 1, so that a pressing force applied in a radial direction of the insert/fitting onto the fitting 2 is directly transmitted to the serrated portions 4d. As a result the serrated portions 4d are pressed onto the outer surface of the pipe 3 and deform slightly, so that a grip between the insert 4 and the pipe 3 is further improved. For a better engagement with the outer surface of the pipe 3, the radial extending tines of the serrated portions 4d are inclined with respect to an axial direction of the insert 4 towards the second end face of the insert 4, so as to facilitate an insertion of the pipe 3 into the insert (an insertion in a direction marked by arrow A), but to make a pulling out of the pipe 3 out of the insert 4 difficult (a pulling out in a direction opposite to the direction marked by arrow A) for ensuring that the pipe 3 remains in its desired position inside the insert 4.

At the second front face, i.e. the lower front face in FIG. 1, the lower portion of the insert 4 comprises a section partially bent radially inwardly, so as to form an undercut portion (or pocket portion) 4e. The undercut portion 4e provides a radial circumferential groove with an opening in the axial direction of the insert 4 towards the first front face of the insert, wherein the groove is adapted to receive an end portion of the pipe 3. When the pipe 3 is arranged at its desired location within the groove, as shown in FIG. 1, the groove is in contact with a lower end face, a lower part of an inner circumferential face and a lower part of an outer circumferential face of the pipe 3. Thus, the groove provides a stopper for the axial movement of the pipe 3 and, furthermore, prevents a delamination of the layers of the pipe 3, as it encloses the end portion of the pipe 3, so that this portion is protected from a fluid flow inside the pipe fitting-system 1 that may lead to a delamination of the pipe layers. Additionally the groove acts for calibrating the pipe 3, i.e. the groove deforms the pipe 3 when inserted into the groove, so that a cross-section of the inserted portion of the pipe becomes circular, in case the pipe 3 is slightly deformed so as to have no circular cross-section. Preferably the undercut portion 4e is elastically deformable such that the undercut portion applies a slight clamping force onto the end portion of the pipe 3 when arranged in the groove. As a result the layers of the pipe 3 are slightly pressed, so that a delamination of the pipe 3 can be securely prevented. Moreover, as can be seen from FIG. 1, the edge of the groove at its open end is rounded/chamfered so as to facilitate the insertion of the pipe 3 into the groove.

The external profile 4f of the undercut portion 4e is formed in a streamlined shape, so as to avoid changes in a fluid flow flowing through the pipe-fitting system 1. Therefore, turbulences of a fluid flow are minimized and thus a pressure loss along the pipe-pipe fitting system 1 is reduced. In particular, the external profile 4f has the form of a part of a slight wave or is a surface with a large radius of curvature or smooth curves extending from the edge at the open end of the groove to the lowermost portion of the insert 4 in FIG. 1. As can be further seen in FIG. 1, the undercut portion 4e and thus its profile is extended downwardly so as to overlap a portion of the fitting 2, where the diameter of the fitting 2 reduces. Thus, the external profile 4f of the undercut portion 4e provides a smooth transition from the inside of the pipe 3 to the inside of the fitting 2 at a portion of the fitting 2, where the diameter of the fitting is reduced, so that abrupt changes in a fluid flow are avoided.

In order to ease an insertion of the insert 4 into the fitting 2, the insert 2 is chamfered or rounded at a transition 4g between the outer circumferential face and the second front face of the insert.

Furthermore, the outer circumferential face of the insert (4) is provided with two grooves (5) each extending in the form of a radial ring around the insert (2). The grooves are provided for coming into engagement with a portion of the fitting which is to be deformed by a radial pressing of the fitting. In this embodiment, each groove (5) has a rectangular cross-section. In FIG. 1, one groove (5) is located above the positions of the sealing ring (2a) and the sealing ring (4a) and is located at a position corresponding to the upper serrated portion (4d) in the axial direction of the insert (4). The other groove (5) is located below the positions of the sealing ring (2a) and the sealing ring (4a) and is located at a position corresponding to the lower serrated portion (4d) in the axial direction of the insert (4). However, it is also possible to provide only one of the two grooves or to provide additional grooves.

Now, the assembly operation of the pipe-fitting system 1 will be described.

At first the insert 4 is inserted with its second front face ahead into a corresponding opening of the fitting 2 in a direction marked by arrow A in FIG. 1. The insert 4 is further moved into the fitting 2 until the flange 4b abuts against the end faces of the opening of the fitting 2. Then the pipe 3 is inserted with one end of the pipe 3 ahead into an opening defined by the first front face of the insert 4 in a direction marked by the arrow A. The pipe 3 is moved further into the inside of the insert 4 until the end of the pipe 3 abuts against the bottom of the groove formed by the undercut portion 4e. In this state, shown in FIG. 1, the insert 4 and the pipe 3 are in the desired position with respect to the fitting 2 for the press-fitting of the same.

In this position, the outer circumferential face of the fitting 2 is radially pressed by a pressing device, such as a pressing machine, at positions which correspond to the positions of the grooves 5 in an axial direction. These positions are marked with arrows F in FIGS. 1 and 2. The pressing onto the outer circumference face of the fitting is performed at a plurality of positions around the outer circumference of the fitting, which positions are preferably distanced by the same angular interval. As a result of the pressing respective portions of the fitting 2 plastically deform into the grooves 5, as shown in FIG. 2, thereby engaging with the grooves 5. Note that FIG. 2 shows that the deformed portions of the fitting 2 do not contact the bottom of the grooves 5. However, it is also possible the deformed portions of the fitting 2 contact the bottom of the grooves 5. Furthermore, it is possible that the edges of the grooves 5 also deform a little bit upon the deformation of the fitting 2, thereby improving the engagement between the insert 4 and the fitting 2. Further, upon the radial pressing of the fitting 2 the insert 4 is pressed onto the pipe 3 such that the serrated portions 4d engage with the surface of the pipe 3. As a result, there is formed a

fluid-tight and pressure resisting seal between the pipe 3, the insert 4 and the fitting 2.

Although the assembly operation is described with the insert 4 being firstly inserted into the fitting and then the pipe 3 being inserted into the insert 4, it is of course possible to firstly insert the pipe 3 into the insert 4 and then insert the insert 4 together with the pipe 3 into the fitting 2.

### Second Embodiment

FIG. 3 shows a pipe-fitting system comprising an insert 4 according to a second embodiment of the present invention. The insert according to the second embodiment is substantially the same as the insert according to the first embodiment. A description of features and functions of the insert of the second embodiment which are the same as those in the first embodiment is omitted here.

The insert of the second embodiment differs from insert of the first embodiment in that the insert 4 is adapted to seal a fitting 2 shown in FIG. 3 being of another type than the fitting shown in FIG. 1. The fitting 2 shown in FIG. 3, which the insert 4 of the second embodiment is adapted to seal, has a sealing ring 2a which is located in a recess/groove formed directly near the end of the fitting 2, whereas the fitting shown in FIG. 1, which the insert 4 of the first embodiment is adapted to seal, has a sealing ring 2a which is provided in a recess/groove located at a distance from the end of the fitting 2.

In order to seal a fitting 2 having a sealing ring 2a provided in a recess/groove formed at the end of the fitting 2, the insert 4 of the second embodiment comprises two sealing rings 4a1 and 4a2. When the insert 4 is arranged at its desired position inside the fitting 2, i.e. when the insert 4 is arranged inside the fitting 2 such that the flange 4b abuts against the end faces of the fitting 2 as shown in FIG. 3, the first sealing ring 4a1 is arranged at an axial position which corresponds to an axial position of the sealing ring 2a of the fitting 2. As in the first embodiment, due to this arrangement, a damaging of the sealing ring 4a1 can be prevented. The second sealing 4a2 ring is located at an axial distance with respect the first sealing ring 4a1. Preferably the axial distance is such that an axial position, where a pressing of the fitting 2 for press-fitting the pipe-fitting system 1 takes place, is located between the sealing rings 4a1, 4a2 or at least such that the axial position of the pressing does not correspond to the axial position of the second sealing ring 4a2.

Moreover, the serrated portions 4d of the insert 4 of the second embodiment are formed on the inner circumferential face of the insert 4 above the first sealing ring 4a1, between the first sealing ring 4a1 and the second sealing ring 4a2 and below the second sealing ring 4a2, when viewed in FIG. 3.

In contrast to the insert of the first embodiment, the insert 4 shown in FIG. 3 comprises only one groove 5 extending as a radial ring around the insert 4 and having a rectangular cross-section. The groove 5 is located distanced to the sealing rings 2a, 4a1, 4a2 in the axial direction of the insert 4, namely, as shown in FIG. 3 between the sealing rings 2a, 4a1 and the sealing ring 4a2. Further, the groove 5 is located at an axial position corresponding to the serrated portions 4d. This embodiment is not limited to the use of only one groove. There can be provided one or more additional grooves. Also the location of the groove 5 is not limited to the above described location. E.g. the groove 5 or one or more additional grooves can be positioned below the second sealing ring 4a2.

In order to provide a fluid tight pipe-fitting-system, a pressing of the fitting 2 is performed in the same manner as in the first embodiment. The pressing is performed at a position corresponding to the location of the groove 5, as marked with arrows F in FIGS. 3 and 4. Upon the pressing a portion of the fitting 2 deforms into the groove 5, thereby engaging with the insert, as shown in FIG. 4. Further, as the groove 5 is located at an axial position corresponding to the serrated portions 4d, upon deformation of the fitting 2, the serrated portions 4d are pressed onto the pipe 3, thereby engaging with the surface of the pipe 3. As a result, a fluid-tight and pressure resisting seal is provided between the pipe 3, the insert 4 and the fitting 2.

Other features and functions of the insert (4) of the second embodiment are the same as those of the insert of the first embodiment.

Moreover, the insert 4 of the second embodiment can also be used for sealing the fitting shown in FIG. 1, where the sealing ring 2a is located at an axial distance from the end face of the fitting 2. Therefore, the second sealing ring 4a2 is preferably located at an axial position which corresponds to an axial position of the sealing ring 2a of the fitting 2, shown in the first embodiment, when the insert 4 is arranged at its desired position inside the fitting 2, i.e. when the insert 4 is arranged inside the fitting 2 such that the flange 4b abuts against end faces of the fitting 2. Besides, it is also possible to use the insert 4 of the first embodiment for sealing the fitting shown in FIG. 3.

### Third Embodiment

FIG. 5 shows a partial sectional view of a pipe-fitting system 1 comprising an insert 4 according to a third embodiment of the present invention. The insert according to the third embodiment is substantially the same as the insert according to the first embodiment. A description of features and functions of the insert of the third embodiment which are the same as those in the first embodiment is omitted here.

The third embodiment differs from the first embodiment in that the insert 4 is not formed of one material, but is a composite. In particular, the insert has a first portion 4A and a second portion 4B surrounding the first portion 4A in a radial direction of the insert 4. The first portion 4A is preferably made of a polymeric material or hard plastic material being rigid, such as PPSU, and the second portion 4B is made of an elastic material, such as rubber (NBR). Thus, the first portion 4A provides a sufficient rigidity that ensures a proper transmitting of a pressing force, when the pipe-fitting system 1 is press-fitted, so that a fluid tight sealing of the pipe-fitting system 1 is achieved by the press-fitting, and the second portion 4B improves the grip between the insert 4 and the fitting 2 and, furthermore, improves the sealing between the fitting 2 and the insert 4 due to elastic deformation thereof.

The first portion 4A and the second portion 4B can be integrally formed, for example, by laminating layers of different materials or can be separate components simply laid over one another.

It is noted that in FIG. 5 the at least one circumferential groove is omitted. Nevertheless, also the insert 4 of the third embodiment is provided with at least one circumferential groove in the same manner as in the first embodiment or second embodiment. The at least one circumferential groove can be formed only in the second portion (4B) or can be formed in the second portion (4B) and the first portion (4A).

Other features and functions of the insert 4 of the third embodiment are the same as those of the insert of the first embodiment and the second embodiment.

1. An insert for a pipe-fitting system comprising:
a fitting; and
a pipe,
wherein said insert is configured to be inserted into said fitting and configured to receive said pipe, an outer diameter of which substantially corresponds to the inner diameter of the inner circumferential face of said insert,
wherein the inner circumferential face comprises a sealing portion configured to seal between said insert and said pipe and a holding portion for holding said pipe, being different from the sealing portion, and
wherein an outer circumferential face of said insert comprises at least one circumferential groove for engaging with a deformed portion of said fitting.

2. An insert according to claim 1, wherein the sealing portion comprises one or two sealing elements provided in radial extending recesses formed in the inner circumferential face of the insert, the sealing element being one of an O-ring, a gasket, and a sealing ring having at least one lip.

3. An insert according to claim 2, wherein the sealing element is a composite comprising a portion made of a rigid material and a portion made of an elastic material.

4. An insert according to claim 1, wherein the holding portion comprises at least one of a protrusion and a serrated portion protruding radially inward from the inner circumferential face and extending in a radial circumferential direction with respect to an axial direction of the insert.

5. An insert according to claim 1, wherein the insert comprises a first positioning portion for axially positioning the insert relative to a fitting with respect to an axial direction of the insert.

6. An insert according to claim 5, wherein the positioning portion is a flange protruding radially outward from the outer circumferential face of the insert at a front face of the insert with respect to an axial direction of the insert.

7. An insert according to claim 1, wherein the insert comprises a second positioning portion for axially positioning a pipe relative to the insert with respect to an axial direction of the insert.

8. An insert according to claim 7, wherein the second positioning portion comprises a section of the insert partially bent radially inward at an end face thereof with respect to an axial direction of the insert such that an undercut portion is formed, the undercut portion being able to receive an end portion of a pipe.

9. An insert according to claim 8, wherein the external profile of the undercut portion has at least one of a streamlined and a rounded shape.

10. An insert according to claim 1, wherein the insert is made of a hard plastic material.

11. An insert according to claim 1, wherein the insert is a composite comprising an inner part made of a hard plastic material having small elasticity and an outer part at least partially surrounding the inner part made of a rubber material having high elasticity.

12. An insert according to claim 1, wherein the at least one circumferential groove is provided at a position which is axially distanced from the sealing portion but which corresponds to the position of the holding portion.

13. Pipe-fitting system comprising:
a fitting; and
a pipe,
wherein said insert is configured to insert into said fitting an inner diameter of which is slightly larger than the outer diameter of the outer circumferential face of said insert, said fitting comprising a sealing element extending radially inside said fitting, wherein the outer circumferential face of said insert is substantially smooth and is arranged in contact with said sealing element,
said insert receiving said pipe the outer diameter of which substantially corresponds to the inner diameter of the inner circumferential face of said insert, wherein
the sealing portion seals between said insert and said pipe and the holding portion holds said pipe, and wherein
the at least one circumferential groove engages with a deformed portion of said fitting.

14. Pipe-fitting system according to claim 13, wherein said portion of said fitting is deformed as a result of a radial pressing of said fitting.

15. Pipe-fitting system according to claim 14, wherein said fitting is radially pressed at positions which are axially distanced from the positions of said sealing element and said sealing portion, but which axially correspond to the position of said holding portion.

16. An insert according to claim 10, wherein the hard plastic material of the insert comprises at least one of polyphenylsulfone, poylvinylidene difluoride, and polypropylene.
